(19) United States
(12) Patent Application Publication
(10) Pub. No.: US 2025/0179362 A1
(43) Pub. Date: Jun. 5, 2025

(54) CROSSLINKED POLYMERIC HIGH TEMPERATURE CORROSION INHIBITOR

(71) Applicant: Baker Hughes Oilfield Operations LLC, Houston, TX (US)

(72) Inventors: Jianzhong Yang, Missouri City, TX (US); Xiaofeng Wang, Katy, TX (US); Bradley G. Harrell, Pearland, TX (US); Enrico Nadres, Houston, TX (US); Onome Ugono, Rosenberg, TX (US); Joseph Arensdorf, Conroe, TX (US)

(73) Assignee: Baker Hughes Oilfield Operations LLC, Houston, TX (US)

(21) Appl. No.: 18/525,632

(22) Filed: Nov. 30, 2023

(51) Int. Cl. C09K 15/22; C08G 73/10; C08G 73/16; C09K 8/54; C10G 29/22

(52) U.S. Cl. CPC C09K 15/22; C08G 73/1032; C08G 73/16; C09K 8/54; C10G 29/22; C09K 2208/32

(57) ABSTRACT

In one aspect, a high-temperature corrosion inhibitor includes a crosslinked polymer, wherein the crosslinked polymer includes at least one polyaromatic carboxylic acid compound and at least one crosslinking agent. In another aspect, a crosslinked polymer for use as a high-temperature corrosion inhibitor includes at least one polyaromatic carboxylic acid compound and ethylene oxide. The polyaromatic carboxylic acid includes benzene-1,2,4,5-tetracarboxylic acid, an anhydride of benzene-1,2,4,5-tetracarboxylic acid, and combinations thereof. In yet another aspect, the disclosure is directed to a method for reducing naphthenic acid corrosion at high temperatures. The method includes the steps of providing a high-temperature corrosion inhibitor that includes a crosslinked polymer and treating a crude oil containing naphthenic acid with the high-temperature corrosion inhibitor.

### FIELD OF THE INVENTION

This invention generally relates to corrosion inhibition and, more particularly, but not by way of limitation, to a formulation and method for inhibiting naphthenic acid corrosion at high temperatures.

### BACKGROUND OF THE INVENTION

The oil and gas industry has continued to improve the equipment available for the exploration, production, transport, storage, refining, and distribution of oil and gas resources. There is an ongoing need to maintain this equipment and to protect existing infrastructure from conditions that promote mechanical failure, such as metal corrosion.

Various corrosion inhibitors have been developed to protect oil and gas equipment from corrosion. At higher temperatures, most of these corrosion inhibitors quickly lose their affinity to metal surfaces and, consequently, their efficacy. Only a very small number of high temperature corrosion inhibitors are available for practical use, and most of these inhibitors are phosphorous based. The organic phosphor compound in these traditional high temperature corrosion inhibitors is poisonous to both zeolite-based hydrotreating catalysts and fluid catalytic cracking catalysts. Other available high temperature corrosion inhibitors are sulfur-based, but these inhibitors are both ineffective and very expensive.

This deficiency of suitable high temperature corrosion inhibitors is particularly problematic for high naphthenic crude processing. Naphthenic acid is a component of heavy crude oil and includes a mixture of various carboxylic acids. Between the temperatures of about 400° F. and 700° F., naphthenic acid corrosion becomes of particular concern for crude processing equipment. Industry approaches to combat naphthenic acid corrosion have included blending crude oil with an oil that has a lower naphthenic acid content, attempting to remove or neutralize the naphthenic acids, and constructing specialized processing units with metals that are inherently more resistant to naphthenic acid corrosion. Each of these industry solutions is costly and disruptive to the crude oil processing system.

A need exists, therefore, for a high-temperature corrosion inhibitor that addresses naphthenic acid corrosion through effective chemical intervention. The present disclosure is directed at these and other deficiencies in the prior art.

### SUMMARY OF THE INVENTION

In one aspect, the disclosure is directed to a crosslinked polymer for use as a high-temperature corrosion inhibitor, where the crosslinked polymer includes at least one polyaromatic carboxylic acid compound and ethylene oxide. The polyaromatic carboxylic acid may include benzene-1,2,4,5-tetracarboxylic acid, an anhydride of benzene-1,2,4,5-tetracarboxylic acid, and combinations thereof.

In another aspect, a high-temperature corrosion inhibitor is disclosed, where the high-temperature corrosion inhibitor includes a crosslinked polymer. The crosslinked polymer includes at least one polyaromatic carboxylic acid compound and at least one crosslinking agent.

In yet another aspect, the disclosure is directed to a method for reducing naphthenic acid corrosion at high temperatures. The method includes the steps of providing a high-temperature corrosion inhibitor that includes a crosslinked polymer and treating a crude oil containing naphthenic acid with the high-temperature corrosion inhibitor.

### DETAILED DESCRIPTION

It has been discovered that a crosslinked polymer can be synthesized to overcome thermal stability barriers and inhibit corrosion in the presence of naphthenic acid. This crosslinked polymer may be particularly useful for inhibiting corrosion at temperatures ranging between about 400° F. and about 700° F. Further, this crosslinked polymer is a phosphor-free and sulfur-free system. In exemplary embodiments, a high-temperature corrosion inhibitor includes the crosslinked polymer, which further includes at least one polyaromatic carboxylic acid compound and at least one crosslinking agent.

The polyaromatic carboxylic acid compound may be a polyaromatic carboxylic acid, an anhydride thereof, or a mixture of polyaromatic carboxylic acid(s) and/or anhydride(s). For example, suitable polyaromatic carboxylic acid compounds include benzene-1,2,4,5-tetracarboxylic acid (BTCA), an anhydride of BTCA, and combinations thereof.

The crosslinking agent component serves to crosslink the polyaromatic carboxylic acid compound, thus overcoming the thermal stability barriers that prevent traditional corrosion inhibitors from operating at high temperatures. Further, the crosslinking agent promotes solubility of the polyaromatic carboxylic acid compound, either on its own or with solvents, so that it can be practically deployed in commercial amounts. The crosslinking agent component may include alkylene oxides, alkylene glycols, alkylene carbonates, and combinations thereof. Suitable alkylene oxides include, but are not necessarily limited to, ethylene oxide, propylene oxide, butylene oxide, and combinations thereof. Among the suitable alkylene glycols are ethylene glycols, polyethylene glycols, propylene glycols, butylene glycols, hexylene glycols, homo- and hetero-oligomers and polymers of one or more of the previously listed glycols, glycerols, and combinations thereof. Examples of suitable oligomers and polymers include, but are not necessarily limited to, those of polyethylene glycol (PEG), polypropylene glycol (PPG), random and block copolymers of PEG and PPG, and combinations thereof.

The crosslinking agent may be present in quantities or concentrations derived as a function of the quantity or concentration of the polyaromatic carboxylic acid compound. In some embodiments, the concentration ratio of polyaromatic carboxylic acid compound to crosslinking agent is within a range from about 1:1 to about 1:20. The concentration ratio may also be within a range from about 1:2 to about 1:10 (polyaromatic carboxylic acid compound: crosslinking agent).

In certain non-limiting embodiments, the crosslinked polymer includes between about 5 weight (wt.) % and about 50 wt. % polyaromatic carboxylic acid compound and between about 0.5 wt. % and about 50 wt. % crosslinking agent. In a non-limiting exemplary embodiment, the crosslinked polymer includes about 25 wt. % polyaromatic carboxylic acid compound and about 25 wt. % crosslinking agent. In some embodiments, the high-temperature corrosion inhibitor may also include at least one fatty acid compound. The fatty acid component provides more control over the molecular weight and solubility of the high-temperature corrosion inhibitor. The fatty acid component may include natural and synthetic fatty acids, fatty acid derivatives, and combinations thereof. Mono fatty acids, dimer fatty acids, trimer fatty acids, and combinations thereof may all be suitable for inclusion in the fatty acid component. Suitable fatty acid derivatives include, but are not necessarily limited to, imidazolines, maleated fatty acids, glycol esters of fatty acids, glycol esters of C₅-C₈₀ alkyl succinic acid/anhydride, glycol esters of alkenyl succinic acid/anhydride, glycol esters of polyisobutylene succinic acid/anhydride, and combinations thereof.

Some embodiments of the high-temperature corrosion inhibitor include between about 10 wt. % and about 50 wt. % polyaromatic carboxylic acid compound, between about 0.5 wt. % and about 50 wt. % alkylene oxide, and between about 0 wt. % and about 50 wt. % fatty acid compound. Other exemplary embodiments include between about 5 wt. % and about 30 wt. % polyaromatic carboxylic acid compound, between about 10 wt. % and about 40 wt. % alkylene oxide, and between about 10 wt. % and about 50 wt. % fatty acid compound. In yet other exemplary embodiments, the high-temperature corrosion inhibitor includes between about 5 wt. % and about 25 wt. % polyaromatic carboxylic acid compound, between about 5 wt. % and about 25 wt. % alkylene oxide, and between about 10 wt. % and about 50 wt. % fatty acid compound.

In another non-limiting exemplary embodiment, the crosslinked polymer includes between about 5 wt. % and about 30 wt. % polyaromatic carboxylic acid compound, between about 10 wt. % and about 40 wt. % crosslinking agent and between about 10 wt. % and about 50 wt. % fatty acid compound, where the fatty acid compound is a glycol ester of C₅-C₈₀ alkyl succinic acid, alkenyl succinic acid, polyisobutylene succinic acid, or a mixture thereof.

The high-temperature corrosion inhibitor may also include a solvent, which may make the crosslinking reaction more homogenous. The solvent component may include solvents such as alkylene carbonates, glycols, glycol ethers, aromatic solvents, alcohols, mineral oil, water, and combinations thereof. For example, the solvent in some embodiments is propylene carbonate. The quantities or concentrations of solvent will not necessarily be derived as a function of the quantity or concentration of the polyaromatic carboxylic acid compound and/or the crosslinking agent. In certain exemplary embodiments, the amount of solvent in the high-temperature corrosion inhibitor is between about 10 wt. % and about 40 wt. % solvent.

A method for reducing naphthenic acid corrosion at high temperatures includes the steps of providing the high-temperature corrosion inhibitor, which includes the crosslinked polymer, and treating a crude oil containing naphthenic acid with the high-temperature corrosion inhibitor.

The step of providing the high-temperature corrosion inhibitor may include reacting at least one polyaromatic carboxylic acid compound and at least one crosslinking agent to form the crosslinked polymer. The reaction of polyaromatic carboxylic acid compound and crosslinking agent progresses rapidly until exhaustion of the crosslinking agent. Gelation may result from the formation of an overly crosslinked moiety that loses its solubility quickly. The reaction must, therefore, be carefully controlled to avoid gelation of the product. Strategies to control the reaction include modifying the molecular weight of the synthesized crosslinked polymer to reduce the occurrence of gelation. Another exemplary strategy is to determine the point of gelation based on the amount of polyaromatic carboxylic acid compound, the amount of crosslinking agent, and the changes in reaction temperature. By chemically determining this gelation point, a checkpoint for stopping the reaction can be established at a time prior to that of the gelation point.

The high-temperature corrosion inhibitor may be particularly useful for corrosion inhibition in high temperature geothermal wells or in atmosphere towers or coker units during the refining process of hydrocarbon stocks. It will be appreciated however that the high-temperature corrosion inhibitor may be injected into various metal equipment or parts, including but not limited to wellbore tubulars, pipelines, wellheads, production tubing, downhole equipment, process equipment, process tanks and conduits, and storage tanks to address the problem of corrosion.

The high-temperature corrosion inhibitor can be delivered in a concentrated form. For wellbore applications, the concentrated form can be applied to the impacted region by injection through capillary tubing, chemical injection plunger, or other treatment chemical delivery mechanisms. For application to surface-based equipment or facilities, the concentrated high-temperature corrosion inhibitor can be applied by pumping, spraying, soaking, or otherwise contacting the equipment/facilities with the high-temperature corrosion inhibitor.

Alternatively, the high-temperature corrosion inhibitor can be mixed with a suitable carrier fluid and pumped into the wellbore or through surface-based facilities and equipment. The carrier fluid may be water, brine, or another aqueous solution. In some embodiments, the high-temperature corrosion inhibitor is mixed into the carrier fluid in a concentration range of between about 1 ppm and about 10,000 ppm (high-temperature corrosion inhibitor/carrier fluid). In other embodiments, the concentration range is between about 10 ppm and about 3,000 ppm.

### Examples—Set Up

Various tests were performed to measure the corrosion rate (Equation 1) of metal specimens (coupons) immersed in a corrosive environment, both in the presence of the high-temperature corrosion inhibitor (treated) and in the absence of the high-temperature corrosion inhibitor (control). The performance of the high-temperature corrosion inhibitor was evaluated by comparing the corrosion rate of the treated coupon to the control coupon, and the difference was expressed as % inhibition (Equation 2). A good high-temperature corrosion inhibitor was defined as one having a higher % inhibition. The tests were performed at conditions approximating the anticipated application environment.

$$Corrosion Rate = \frac{K \cdot W}{A \cdot ρ \cdot T} \qquad ( Equation 1 )$$

### Where:

W=Metal loss (g)
A=Coupon surface area (cm²)
ρ=Alloy density (g/cm³)
T=Test duration (hours)
K=3.45×10⁶ (for units of mils per year or mpy)

$$\% Inhibition = 100 \times ( \frac{C {R}_{control} - C {R}_{i nhibitor}}{C {R}_{control}} ) \qquad ( Equation 2 )$$

### Where:

CR_{control}=Corrosion rate of control (i.e., no inhibitor)
CR_{inhibitor}=Corrosion rate of treated (i.e., with inhibitor)

Measured amounts of commercially available naphthenic acids (NA) of nominal total acid number (TAN) and heavy, highly refined mineral oil were added to a test vessel. The NA was added to the mineral oil in a proportion to achieve a TAN of about 9-10 mg KOH/g. The test vessel was then fitted with a paddle stirrer, thermocouple, condenser, gas inlet tube, and two coupons. Once the vessel was sealed, the test fluid (treated or control) was stirred at about 400 rpm, and nitrogen was passed through the test fluid for 30-60 minutes to remove oxygen. Afterward, a mixture of 1% H₂S in nitrogen was passed through the test fluid for the duration of the test to provide H₂S and maintain a de-aerated environment during the test. At the end of 20 hours, the coupons were removed, cleaned, and weighed. The difference between the initial and final masses of each coupon provided a direct measurement of metal loss over the duration of the test. Finally, corrosion rates were calculated using the metal loss recorded for the coupons.

### Example I

A round of testing was performed to evaluate benzene-1,2,4,5-tetracarboxylic acid (BTCA) crosslinked by direct ethoxylation in propylene carbonate. For these tests, a mixture of 80 g BTCA, 6 g N,N-dimethyloctadecylamine (DMOA), and 130 g propylene carbonate was charged to a pressure reactor. The mixture was mechanically stirred and heated up to 110° C., followed by dehydration through N₂ sparging. Samples were periodically withdrawn from the mixture to check water content until Karl Fisher <0.1% was achieved. After the dehydration of the mixture, about 12 eq. of ethylene oxide per BTCA molecule was charged to the reactor, and the reaction was carried out at 110° C. for 2 hours. After the reaction was completed, the reactor was cooled to 70° C. and N₂ sparging was again applied to remove any residual unreacted ethylene oxide. The reactor was cooled down further to room temperature to discharge the product. The sample was tested as high temperature corrosion inhibitor without further modification.

### Example II

Other tests were performed to observe BTCA crosslinked by ethylene oxide in the presence of tall oil fatty acid (TOFA)dimer acid with DMOA as a catalyst and aromatic 100 as a solvent. The procedure from Example 1 was repeated with the following modifications. A mixture of 100 g BTCA, 82.5 g TOFA dimer acid, 5.54 g DMOA, and 67.5 g aromatic 100 was initially charged to the pressure reactor. After dehydration, 165 g of ethylene oxide was charged to the reactor. The final product was diluted to 70% active of the reaction product by propylene carbonate before testing as the high-temperature corrosion inhibitor.

### Example III

Yet other tests were performed to observe BTCA crosslinked by ethylene oxide in the presence of trimer acid with DMOA as a catalyst and with propylene carbonate and aromatic 100 as solvents. The procedure for Example 1 was repeated with the following modifications. A mixture of 80 g BTCA, 60 g maleated oleic trimer acid, 4.60 g DMOA, 60 g propylene carbonate, and 40 g aromatic 100 was initially charged to the pressure reactor. After dehydration, 80 g of ethylene oxide was charged to the reactor. The final product was diluted to 70% active of the reaction product by propylene carbonate before testing as the high-temperature corrosion inhibitor.

### Example IV

Additional tests were performed to evaluate BTCA crosslinked by ethylene oxide in the presence of trimer acid, catalyzed by Baker Hughes commercial product CRO111, with propylene carbonate and Aromatic 100 as the solvents. The procedure for Example I was repeated with the following modifications. A mixture of 80 g BTCA, 80 g, maleated oleic trimer acid, 19.2 g CRO111 (Tall oil, reaction products with diethylenetriamine), 60 g propylene carbonate, and 20 g Aromatic 100 was initially charged to the pressure reactor. After dehydration, 80 g of ethylene oxide was charged to the reactor. The final product was diluted to 70% active of the reaction product by propylene carbonate before testing as the high-temperature corrosion inhibitor.

### Example V

Yet additional tests were performance for BTCA crosslinked by ethylene glycol or ethylene oxide in the presence of C12-C₈₀ alkenyl succinic anhydride (i.e., alkenyl succinic anhydride having between 12 and 80 carbon atoms) (ASA) and polyisobutylene succinic anhydride. In a specific example, 80 g of an alkenyl succinic anhydride mixture (containing 48 wt. % C₁₆ ASA, 32 wt. % C₁₈ ASA, and 20 wt. % C₂₀-C₂₄ ASA), 27.31 g ethylene glycol, 20 g Aromatic 100, and 1 g of dodecylbenzene sulfonic acid were charged into a three-neck flask. The mixture was purged with gentle flow of N₂ and heated to 160° C. until ˜3.8 g of water was removed. Then the temperature was dropped to 100° C., and pyromellitic dianhydride (PMDA), the dianhydride form of BTCA, was added into the homogeneous solution and mixed at 140° C. for 4 hrs. The solution formed a viscous product with the complete disappearance of the PMDA in the reactor pot. The final product (with a mass of 5,317 daltons) was diluted to 90% active of the reaction product by propylene carbonate before testing as the high-temperature corrosion inhibitor.

TESTING RESULTS FOR EXAMPLES

| | Concentration | Corrosion Rate | |
|---|---|---|---|
| Inhibitor | (ppm) | (MPY) | % Inhibition |
| Example I | 1000 | 23.5 | 65 |
| Example II | 750 | 19.0 | 70.5 |
| Example III | 750 | 17.5 | 74 |
| Example IV | 750 | 15.2 | 78 |
| Example V | 750 | 14.9 | 63.4 |

In the foregoing specification, the invention has been described with reference to specific embodiments thereof. However, it will be evident that various modifications and changes can be made thereto without departing from the broader scope of the invention as set forth in the appended claims. Accordingly, the specification is to be regarded in an illustrative rather than a restrictive sense. For example, polyaromatic carboxylic acid compounds and crosslinking agents, fatty acid compounds, solvents, corrosion treatment procedures, proportions, dosages, temperatures, and amounts not specifically identified or described in this disclosure or not evaluated in a particular Example are still expected to be within the scope of this invention.

As used herein, ranges of concentration ratios should be interpreted to include any and all ratios within the prescribed ranges. For example, embodiments where the ratio of polyaromatic carboxylic acid compound to cross-linking agent is expressed within the range of 1:1 to 1:4 should be interpreted to also include the discrete intermediate concentrations ratios of 1:2 and 1:3 (polyaromatic carboxylic acid compound: cross-linking agent) and fractional ratios therebetween (e.g., 1:1.1 and 1:3.5). It will be understood that, as used herein, a range of X wt. % to Y wt. % will be interpreted to include the disclosure of each discrete integer value between X and Y (e.g., X, X+1, X+2 . . . . Y−1, Y).

The present invention may suitably comprise, consist of, or consist essentially of the elements disclosed and may be practiced in the absence of an element not disclosed. As used herein, the singular forms “a,” “an,” and “the” are intended to include the plural forms as well, unless the context clearly indicates otherwise. As used herein, the term “about” in reference to a given parameter is inclusive of the stated value and has the meaning dictated by the context (e.g., it includes the degree of error associated with measurement of the given parameter). As used herein, the term “and/or” includes any and all combinations of one or more of the associated listed items.

It is claimed:

1. A crosslinked polymer for use as a high-temperature corrosion inhibitor, wherein the crosslinked polymer comprises:
at least one polyaromatic carboxylic acid compound selected from the group consisting of benzene-1,2,4,5-tetracarboxylic acid, an anhydride of benzene-1,2,4,5-tetracarboxylic acid, and combinations thereof; and
ethylene oxide.

2. The crosslinked polymer of claim 1 comprising:
between about 5 wt. % and about 50 wt. % polyaromatic carboxylic acid compound; and
between about 0.5 wt. % and about 50 wt. % ethylene oxide.

3. The crosslinked polymer of claim 1 comprising:
about 25 wt. % polyaromatic carboxylic acid compound; and
about 25 wt. % ethylene oxide.

4. A high-temperature corrosion inhibitor comprising:
a crosslinked polymer, wherein the crosslinked polymer comprises:
at least one polyaromatic carboxylic acid compound; and
at least one crosslinking agent.

5. The high-temperature corrosion inhibitor of claim 4, wherein the at least one polyaromatic carboxylic acid compound is selected from the group consisting of benzene-1,2,4,5-tetracarboxylic acid, an anhydride of benzene-1,2,4,5-tetracarboxylic acid, and combinations thereof.

6. The high-temperature corrosion inhibitor of claim 4, wherein the at least one crosslinking agent is selected from the group consisting of alkylene oxides, alkylene glycols, alkylene carbonates, and combinations thereof.

7. The high-temperature corrosion inhibitor of claim 6, wherein the alkylene oxide, if present, is selected from the group consisting of ethylene oxide, propylene oxide, butylene oxide, and combinations thereof.

8. The high-temperature corrosion inhibitor of claim 6, wherein the alkylene glycol, if present, is selected from the group consisting of ethylene glycols, polyethylene glycols, propylene glycols, butylene glycols, hexylene glycols, homo- and hetero-oligomers and polymers of one of more of the previously listed glycols, glycerols, and combinations thereof.

9. The high-temperature corrosion inhibitor of claim 4, wherein a concentration ratio of polyaromatic carboxylic acid compound to crosslinking agent in the crosslinked polymer is within a range from about 1:1 to about 1:20 (polyaromatic carboxylic acid compound: crosslinking agent).

10. The high-temperature corrosion inhibitor of claim 4, wherein a concentration ratio of polyaromatic carboxylic acid compound to crosslinking agent in the crosslinked polymer is within a range from 1:2 to about 1:10 (polyaromatic carboxylic acid compound: crosslinking agent).

11. The high-temperature corrosion inhibitor of claim 4, further comprising at least one fatty acid compound selected from the group consisting of natural and synthetic fatty acids, fatty acid derivatives, and combinations thereof.

12. The high-temperature corrosion inhibitor of claim 11, comprising:
between about 5 wt. % and about 30 wt. % polyaromatic carboxylic acid compound;
between about 10 wt. % and about 40 wt. % crosslinking agent; and
between about 10 wt. % and about 50 wt. % fatty acid compound, wherein the fatty acid compound is selected from the group consisting of glycol esters of C₅-C₈₀ alkyl succinic acid, C₅-C₈₀ alkenyl succinic acid, polyisobutylene succinic acid and mixtures thereof.

13. The high-temperature corrosion inhibitor of claim 11, wherein the at least one crosslinking agent is an alkylene oxide, the high-temperature corrosion inhibitor comprising:
between about 10 wt. % and about 50 wt. % polyaromatic carboxylic acid compound;
between about 0.5 wt. % and about 50 wt. % alkylene oxide; and
between about 0.5 wt. % and about 40 wt. % fatty acid compound.

14. The high-temperature corrosion inhibitor of claim 13, comprising:
between about 5 wt. % and about 30 wt. % polyaromatic carboxylic acid compound;
between about 10% wt. % and about 40 wt. % alkylene oxide; and
between about 10 wt. % and about 50 wt. % fatty acid compound.

15. The high-temperature corrosion inhibitor of claim 14, comprising:
between about 5 wt. % and about 25 wt. % polyaromatic carboxylic acid compound;
between about 5 wt. % and about 25 wt. % alkylene oxide; and
between about 10 wt. % and about 50 wt. % fatty acid compound.

16. The high-temperature corrosion inhibitor of claim 4, further comprising a solvent selected from the group consisting of alkylene carbonates, glycols, glycol ethers, aromatic solvents, alcohols, mineral oil, water, and combinations thereof.

17. The high-temperature corrosion inhibitor of claim 16, wherein the solvent is propylene carbonate.

18. The high-temperature corrosion inhibitor of claim 16, comprising between about 10 wt. % and about 40 wt. % solvent.

19. A method for reducing naphthenic acid corrosion at high temperatures, the method comprising the steps of:
providing a high-temperature corrosion inhibitor, wherein the high-temperature corrosion inhibitor comprises a crosslinked polymer; and
treating a crude oil containing naphthenic acid with the high-temperature corrosion inhibitor.

20. The method of claim 19, wherein the step of providing the high-temperature corrosion inhibitor further comprises the step of reacting at least one polyaromatic carboxylic acid compound and at least one crosslinking agent to form the crosslinked polymer.
